(19) United States
(12) Patent Application Publication
(10) Pub. No.: US 2017/0154029 A1
(43) Pub. Date: Jun. 1, 2017

(54) SYSTEM, METHOD, AND APPARATUS TO NORMALIZE GRAMMAR OF TEXTUAL DATA

(71) Applicant: ROBERT MARTIN KANE, CHULA VISTA, CA (US)

(72) Inventor: ROBERT MARTIN KANE, CHULA VISTA, CA (US)

(21) Appl. No.: 15/364,711

(22) Filed: Nov. 30, 2016

Related U.S. Application Data
(60) Provisional application No. 62/261,284, filed on Nov. 30, 2015.

(51) Int. Cl. G06F 17/27

(52) U.S. Cl. CPC G06F 17/274; G06F 17/2705; G06F 17/2785; G06F 17/277

(57) ABSTRACT

The present inventive subject matter is drawn to method, system, and apparatus to analyze and refine the linguistic grammar of textual data. In one aspect of this invention, a method for normalizing grammar of textual data stored in a computer memory is presented, where any non-grammatical occurrences in the textual data is processed and resolved; a lexicon classification of the textual data content is performed; and any ambiguous classification of any of the textual data content is resolved. In another aspect of the invention, a non-transitory computer-readable medium for normalizing grammar of textual data may include instructions stored thereon, that when executed on a processor, normalizes grammar of textual data.

The present application claims priority to U.S. provisional patent applications No. 62/261,284, filed on Nov. 30, 2015, the content of which is included herein by reference. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

This invention relates, in general, to the functional linguistic analysis areas. Specifically, this invention relates to a system and method to analyze and refine the linguistic grammar of textual data.

### BACKGROUND OF THE INVENTION

In many cases, a written document is a contract, in one form or another, between two entities. This contract contains critical information that may steer the actions of either of or both entities, and on which hinges the state of their relationship. That puts the clarity and accuracy of the contents of this written document at a high level of importance.

This concept applies to many industries and fields, where the process of communicating specifications to skilled personnel is equivalent to that of an engineering drawing and will demand the utmost efficiency to streamline the implementation of the blueprints outlined by these specifications. Any break down in this communication process creates ambiguities with respect to the rights and duties, and leads to contractual conflicts between the parties. Further, the absence of this desired efficient communication comes at great cost, financially, logistically, psychologically, etc.

For example, a traditional process to formalize the requirements for software development project entails the reduction of the technical specification to sentence level accountability. This approach fails to consider the interdependent relationship between sentence level components, and fails to consider grammatical ambiguities that may exist within the sentence level requirements. Consequently, contractual conflicts arise due to the failure to achieve the intent of the original specification, and cost overruns that result from additional efforts to correct the already ongoing implementation of the specification. Additionally, quite often the risk that a contractor and a customer enterprise will fail elevates to unacceptable or irrecoverable levels. One of the many benefits of this invention is to mitigate this risk by achieving the highest level of understanding of the technical requirements prior to the commencement of development. Additionally, this invention promotes the availability and sharing of a unified vision of the requirements during the system development process among all the parties of the contract.

Therefore, it is necessary that written specifications be compiled in a systematic way that ensures their accuracy and completeness. This is not an easy task. The difficulty to reach sufficient level of accuracy and completeness arises from the fact that establishing specifications is a tough abstraction problem making miscommunication between the parties virtually unavoidable. This poses potential problems to the development of dependable systems, where these specifications are necessary to ensure that a given system does not enter an undefined state. Thus, there is a need for a system and method to refine and reconstruct such data to produce the desired work product.

The present invention is a data processing system and method to normalize grammar of text. The normalized text may then undergo semantic analysis that reaches the objective of undefined state detection. After that, the text may be introduced into an automated reader application that may provide the user of the system the ability to read the document in a conventional manner. The reader may also provide the ability to view the linkages between semantic elements of the overall text. When two related sets of text have been processed according to this invention, the two sets may be viewed in the same Semantics-aware context to identify relationships between the two sets. When the analysis is complete, the textual document is transformed to a model-based expression of required functionality that is highly amenable to automated code development and more likely to reveal benefits of code reuse.

### SUMMARY OF THE INVENTION

The present inventive subject matter is drawn to method, system, and apparatus to analyze and refine the linguistic grammar of textual data. In one aspect of this invention, a method for normalizing grammar of textual data is presented.

In some embodiments, the method for normalizing grammar of textual data may be configured to automatically providing access to the computer memory, where the computer memory may be configured to store a plurality of textual data, and providing access to a network, such that the computer memory is connected to the network.

In some embodiments, the method may further comprise the steps of dividing the textual data into a plurality of words, and inserting each of the plurality of words into a matrix. In some embodiments the method may comprise the steps of determining whether any of the plurality of words is a non-grammatical expression, and if a first word of the plurality of words is a non-grammatical expression, replacing the first word with a second word into the matrix, wherein the second word is a grammatical and semantic equivalent of the first word.

The method may also comprise the steps of determining the Part of Speech (PoS) classification for each of the words in the matrix, and determining whether a third word in the matrix has an ambiguous PoS classification.

In other preferred embodiments, the method may comprise the steps of resolving the ambiguous PoS classification of the third word, aggregating the plurality of words into one or more phrases, and presenting the one or more phrases to a user for approval.

In some embodiments, the first word may be an idiomatic expression. In other embodiments, the step of determining whether the first word is a non-grammatical expression may further comprise the steps of determining whether the first word exists in a lexicon, and if the first word exists in the lexicon, determining whether a position of the first word in the matrix is not supported by any of a plurality of grammar rules.

The lexicon may be stored in the computer memory, in some preferred embodiment. In other preferred embodiments, the plurality of grammar rules may be stored in one or more grammar rules repositories, wherein at least one of the one or more grammar rules repositories is stored in the computer memory, in some of these embodiments.

Further, in some embodiments, the step of replacing the first word with a second word into the matrix may comprise the steps of looking up the second word from a lexicon, where the first word and the second word share the same meaning, and determining whether the position of the second word in the matrix is supported by any of a plurality of grammar rules.

The step of determining the Part of Speech (PoS) classification for each of the words in the matrix may comprise the following steps in other embodiments: determining whether each of the words in the matrix exist in a lexicon, and if a fourth word in the matrix exists in the lexicon, determining the corresponding lexicon PoS definition of the fourth word, and storing the lexicon PoS definition of the fourth word in the matrix. The lexicon PoS definition of the fourth word may comprise an ambiguity flag, some of these embodiments. In other preferred embodiments, the step of resolving the ambiguous PoS classification of the third word may comprise the step of evaluating the context of the third word. In some of these embodiments, the step of evaluating the context of the third word may comprise the steps of determining whether an article precedes the third word, determining whether an adjective precedes the third word, and determining whether a preposition precedes the third word.

In some preferred embodiments, the method may further comprise the steps of detecting any non-normal grammatical construct in the one or more phrases, and a non-normal grammatical construct is detected in the one or more phrases, replacing the non-normal grammatical construct with a normal grammatical construct, wherein the normal grammatical construct may be a semantic equivalent of the non-normal grammatical construct, in a subset of these embodiments.

In other preferred embodiments, the step of replacing the non-normal grammatical construct with a normal grammatical construct may further comprise the steps of looking up the normal grammatical construct from a lexicon, where the non-normal grammatical construct and the normal grammatical construct share the same semantic meaning, and determining whether the position of the normal grammatical construct in the matrix is supported by any of a plurality of grammar rules.

In another aspect of the invention, a non-transitory computer-readable medium for normalizing grammar of textual data may include instructions stored thereon, that when executed on a processor, perform the steps including: dividing the textual data into a plurality of words; inserting each of the plurality of words into a matrix; determining whether any of the plurality of words is a non-grammatical expression; if a first word of the plurality of words is a non-grammatical expression, replacing the first word with a second word into the matrix, wherein the second word is a grammatical and semantic equivalent of the first word; determining the Part of Speech (PoS) classification for each of the words in the matrix; determining whether a third word in the matrix has an ambiguous PoS classification; if the third word has an ambiguous PoS classification, resolving the ambiguous PoS classification of the third word; aggregating the plurality of words into one or more phrases; and presenting the one or more phrases to a user for approval.

### BRIEF DESCRIPTION OF THE FIGURES

The invention may be better understood by referring to the following figure(s). The components in the figures are not necessarily to scale, emphasis instead being placed upon illustrating the principles of the invention. In the figures, like reference numerals designate corresponding parts throughout the different views.

FIG. 1 illustrates an example computing environment in which a specification management system interacts with user computers and different proprietary systems.

FIG. 2 illustrates an example specification management system of some embodiments.

FIG. 3 illustrates a method for processing textual data received from a specification system or a user, and presenting the normalized textual data.

FIG. 4 illustrates an example of a user review and approval form of the normalized requirements reconstructions.

### DETAILED DESCRIPTION

In the following description, reference is made to the accompanying drawings and figures that form a part hereof, and which show, by way of illustration, specific preferred embodiments in which the invention may be practiced. Other examples of implementations may be utilized and certain changes may be made in the relative proportions, arrangements, or configurations of the components described herein without departing from the scope of the present invention.

In the following description, numerous specific details are set forth to provide a more thorough description of the invention. It will be apparent, however, to one skilled in the pertinent art, that the invention may be practiced without these specific details. In other instances, well known features have not been described in detail so as not to obscure the invention. Reference is made to the accompanying drawings and figures that form a part hereof, and which show, by way of illustration, specific preferred embodiments in which the invention may be practiced. Other examples of implementations may be utilized and certain changes may be made in the relative proportions, arrangements, or configurations of the components described herein without departing from the scope of the present invention.

### TERMINOLOGY

Unless otherwise specifically defined, terms, phrases and abbreviations used in this disclosure are commonly known in the art of information technology and computer programming and may be in use in one or more computer programming languages and the definition of which is available in computer programming dictionaries. However, the use of the later terms, phrases and abbreviation in the disclosure is meant as an illustration of the use of the concept of the invention and encompasses all available computer programming languages provided that the terms, phrases and abbreviations refer to the proper computer programming instruction(s) that cause a computer to implement the invention as disclosed. Prior art publications that define the terms, phrases and abbreviations are included herein by reference.

In the following, a system according to the invention, unless otherwise specifically indicated, comprise a client machine and/or server machine and any necessary link, such as an electronic network. A client machine comprise such devices as personal computers (e.g., a laptop or desktop etc.), hardware servers, virtual machines, personal digital assistants, portable telephones, tablets, or any other device. The client machines and servers provide the necessary means for accessing, processing, storing, transferring or otherwise carrying out any type of data manipulation and/or communication.

The methods of the invention enable the system, depending of the implementation, to remotely of locally query, access and/or upload data from/onto a network resource, such a World Wide Web (WWW) location using, for example, the Internet as a network.

A machine in the system (e.g., client and/or server machine) refers to any computing machine enabling a user or a program process to access a network and execute one or more steps of the invention as disclosed. For example, a machine may be a User Terminal such as a stand-alone machine or a personal computer running an operating system such as, MAC-OS, WINDOWS, UNIX, LINUX, or any other available operating systems. A machine may be a portable computing device, such as a smart phone or tablet, running a mobile operating system such as iOS, Android or any other available operating system. A Host Machine may be a server, control terminal, network traffic device, router, hub, or any other device that may be able to access data, whether stored on disk and/or memory, or simply transiting through a network device. A machine is typically equipped with hardware and program applications for enabling the device to access one or more networks (e.g., wired or wireless networks), storage means for storing data (e.g., computer memory) and communicating means for receiving and transmitting data to other devices. A machine may be a virtual machine running on top of another system, e.g., on a standalone system or otherwise in a distributed computing environment, to which it is commonly referred as cloud computing.

A “user” as used in this disclosure refers to any person using a computing device, or any process (e.g., a server and/or a client process) that may be acting on behalf of a person or entity to process and/or serve data and/or query other devices for specific information.

In other instances, the disclosure refers to a “user” as being a user who utilizes the output of the system according to the invention (e.g., feedback information) to create new digital media. A “user” is enabled to carry out any type of data manipulation.

In the following disclosure, a Uniform Resource Locator (URL) refers to the information required to locate a resource accessible through a network. On the Internet, the URL of a resource located on the World Wide Web usually contains the access protocol, such as Hypertext Transport Protocol (HTTP), an Internet domain name for locating the server that hosts the resource, and optionally the path to a resource (e.g., a data file, a script file, and image or any other type data) residing on that server.

An ensemble of resources residing on a particular domain, and any affiliated domains or sub-domains, are typically referred as a WWW site, or “website” in short. For example, data documents, stylesheets, images, scripts, fonts, or other files are referred to as resources.

Resources of a website are typically remotely accessed through an application called “Browser”. The browser application is capable of retrieving a plurality of data type from one or more resource locations, and carrying out all the necessary processing to present the data to the user and allow the user to interact with the data.

A Browser may automatically conduct transactions on behalf of the user without specific input from the user. For example, the browser may retrieve and upload uniquely identifying data (commonly referred as “cookies”), from and to websites.

Typically, an operator of (or process executed on) a machine may access a website, for example, by clicking on a hyperlink to the website. The user may then navigate through the website to find a web page of interest. Public information, personal information, confidential information, and/or advertisements may be presented or displayed via a browser window in the machine or by other means known in the art.

In the following disclosure, communication means (e.g., websites) specialized in providing tools for users to communicate with one another, or a user with a group of other users, share data or simply access a stream of digital data, are typically referred as social media.

In the context of this Invention, the following definitions are noted. A “Word” is any string of characters that may appear in text that does not include a space character. Alternatively, a Word may be all contiguous characters that appear in text between two spaces. The term “Word” may include a string of characters, even though the string of characters may not appear in any standard dictionary.

The term “Semantics” refers to the linkages between entities. The active linkages between entities include control, subordination (inverse control), and equivalence (identity). The “Semantic Context” of a design consists of active entities, objects and actions. A “Semantic Entity” is an active entity that affects its own Semantic Context. A Semantic Entity is a Noun which may be either a simple Part of Speech (PoS) or a Grammatical Construct. In the context of a software design specification, a Semantic Entity is a system or subsystem within the design. A “Semantic Object” is an inactive entity that carries information between active entities. In the context of a software design specification these are data variables. A “Semantic Action” is the means by which an active entity affects its Semantic Context. In the context of a software design, the active entity (system or subsystem) modifies the state of an inactive entity (a data variable). The final action is to change the state of the inactive entity but the algorithm used to guide the state change is of unconstrained complexity. PoSs may include Standard English grammatical parts where examples are Noun, Verb, Preposition, etc.

A “Lexicon” is a list of Words that are recognizable as semantically relevant. Each word listed in the Lexicon is assigned a PoS. A “Lexical word” is any word that appears within the Lexicon. A “Non-Lexical word” is any word that does not appear within the Lexicon. In some embodiments, all words listed in the Lexicon may be stored in non-proper form (i.e., in lower case). In these embodiments, the presence of upper case characters indicates that the word is non-lexical, where a non-lexical word has semantic meaning beyond that assigned by Standard English.

The “Rules of Grammar” define relationships between PoSs that are observed in Standard English. These rules specify PoS sequences that are parts of complex Grammatical Constructs, rules for resolution of PoS ambiguity, and rules for non-grammatical resolution (idiomatic and rhetorical cases). The term Grammatical Rules is interchangeable with this term.

“Grammatical Context” is the PoSs assigned to Words that are in proximity to the Word of interest. A “Grammatical Construct” is a set of contiguous words that form clauses or phrases. A “Non-Grammatical Construct” is a set of contiguous words that do not conform to Grammatical Rules. An “Idiomatic Expression” is a Non-Grammatical Construct that has semantic relevance. In such cases, an alternative Grammatical Construct that carries the same semantic intent, may be processed using Grammatical Rules. A “Rhetorical Inclusion” is a Non-Grammatical Construct that has no semantic relevance. The Rhetorical Inclusion is used a spoken language to emphasize or to focus attention to some aspect of the semantic context. In a design specification these inclusions are superfluous since the entire semantic context is contractually binding.

A Sentence Parts (SeP) is a Standard English sentence part, where the pertinent SePs may include a Subject, a Verb and a Direct Object. These SePs are direct semantic parts. SePs may consist of simple PoS's or Grammatical Constructs where the Grammatical Constructs assume the roles of complex PoS's. Note that phrases and clauses are indirect Semantic parts that indicate relational rather than direct Semantics. “Grammatical Normalcy” is grammar that can be parsed by the rules comprising the Invention to resolve semantic intent. In this regard it should not be confused with grammatical correctness in any abstract or absolute sense.

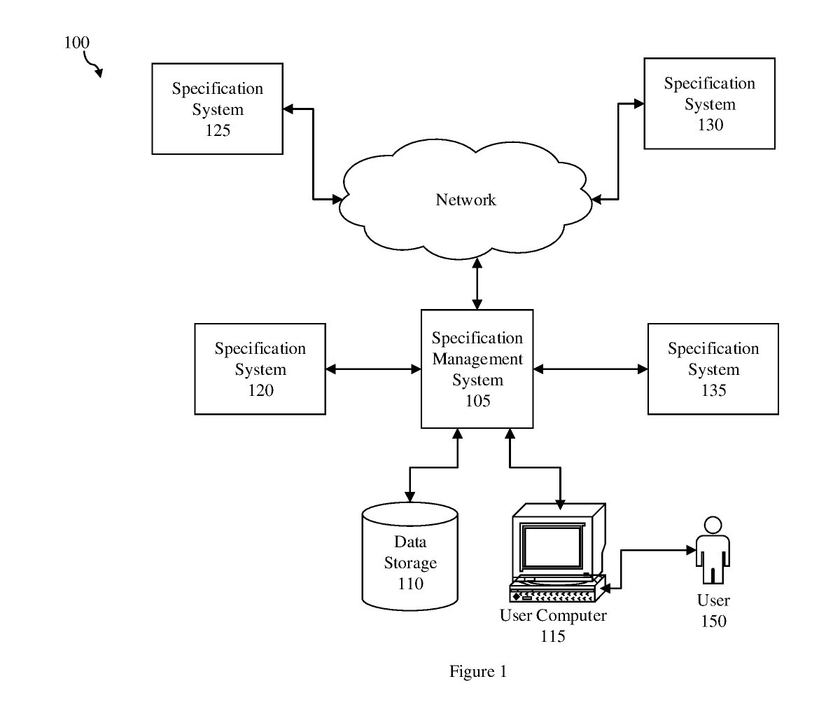

This invention provides for a system and method to analyze textual data input to produce an explicit expression, for the purposes of grammatically refining the input. FIG. 1 illustrates an example computing environment in which a system, according to one embodiment of this invention, interacts with user computers and different proprietary systems. As shown, a specification management system 105 may be communicatively coupled with a data storage 110. The specification management system 105 may also be communicatively coupled with several different specification systems 120-135, as well as a user computer 115.

In some embodiments, the data storage 110 may be a permanent data storage (computer memory) such as a hard drive, a flash memory, etc. The data storage 110 may store specification data received from customers and information for converting the textual data based on grammatical analysis. The data storage 110 in some embodiments may be fully integrated with the specification management system 105. In other embodiments, the data storage 110 may be partially or totally setup separately from the specification management system 105, and may be communicatively coupled with the specification management system 105 over a network (e.g., a Local Area Network (LAN), a Wide Area Network (WAN), the Internet, etc.).

In some embodiments, the user computer 115 may be operated by a user 150 who has an interest in communicating system specification information. The user computer 115 may communicate with the specification management system 105 over a network. The specification management system 105 may also be communicatively coupled with several specification systems 120-135. In some embodiments, at least some of the specification systems (120-135) may be associated with the same company or entity. In these embodiments, the specification systems of the company or entity may perform different functions for different purposes for the company or entity.

In some embodiments, the user may receive requests from an end-consumer or other interested parties. Thereupon the user may utilize the user computer 115 to interface with the specification management system 105 to analyze and/or process the specifications or other information in question. The user computer 115 may be directly integrated with the specification management system 105, or may be connected over a LAN. In these embodiments, the specification management system 105 and the user computer 115 may be setup in an internal network (e.g. LAN) of a company. In addition, one or more of the specification systems 120-135 of different companies may be connected to the specification management system 105 of the company over the Internet.

In other embodiments, the user computer 115 may be connected to the specification management system 105 over the WAN or the Internet. In such embodiments, the specification management system 105 may be connected to at least one of the specification systems 120-135 over LAN of the company in some of these embodiments, or over the WAN or the Internet in other embodiments.

The user computer 115 may also be operated by an end-consumer. In these embodiments, the end-consumer may utilize the user computer 115 to interface with the specification management system 105 to analyze and/or process specifications or other information. The user computer 115 may be connected to the specification management system 105 over the Internet. In these embodiments, the specification management system 105 may be connected to one or more of the specification systems 120-135 over a LAN of the company in some of these embodiments. In other embodiments, the specification management system 105 may be setup in the LAN of a company, and may be connected to the different specification systems 120-135 of different companies or over the Internet.

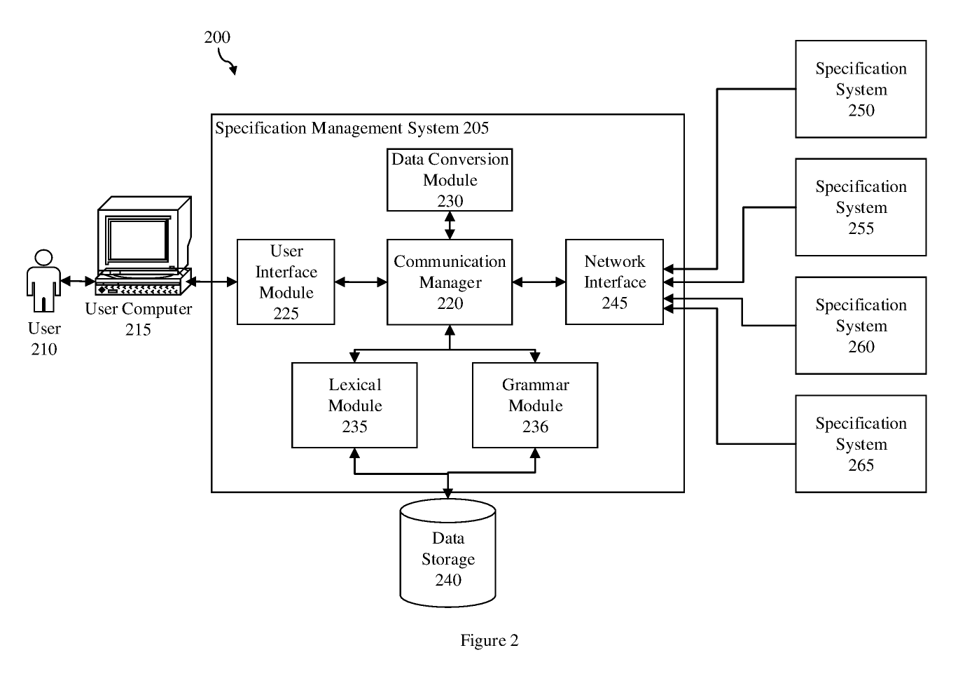

FIG. 2 illustrates an example specification management system of some embodiments. As shown, the specification management system 205 may include a communication manager 220, a data conversion module 230, a lexical module 235, a grammar module 236, a user interface module 215, and a network interface 245.

In some embodiments, the communication manager 220, the data conversion module 230, the lexical module 235, the grammar module 236, the user interface module 215, and the network interface 245 may be implemented as software modules that can be executed by at least one processing unit (e.g., a processor, a processing core, etc.) of the specification management system 205 to perform different functions.

In some embodiments, the specification management system 105 may be implemented as computer software that is installed on a computer system operated by a company. In other embodiments, the specification management system 205 may be implemented as a service that may that is accessible by one or more companies over a network (e.g., the Internet). In these embodiments, the specification management system 205 may also include a World Wide Web (WWW) Server, through which a consumer or another company may access the service(s) provided by the specification management system 205 over the Internet. In yet other embodiments, the specification management system 205 may be implemented as a WWW Application, which the customer or another company may access using a WWW Browser over the Internet.

As shown, the specification management system 205 may be communicatively coupled with a data storage 240. As mentioned, the data storage 240 in some embodiments may be integrated with the same set of devices on which the specification management system 205 is installed. In other embodiments, the data storage 240 may be physically removed from the specification management system 205, and the specification management system 205 may communicate with the data storage 240 over a network. (e.g. a LAN, a WAN, the Internet, etc.)

The specification management system 205 may also be communicatively coupled with at least one user computer 215. In some embodiments, the communication manager 220 may instruct the user interface module 225 to provide a graphical user interface (GUI) through which the user 210 who uses the user computer 215 may interact with the specification management system 205.

In addition to the user computer 215, the specification management system 205 is also shown to be communicatively coupled with several different specification systems 250-265 that may be operated by one or more companies or entities. Different companies or entities often times develop their own proprietary specification systems, which are incompatible with one another. In some embodiments, the specification management system 205 may utilize the data storage 240 to access and store data relevant to the grammatical processing of the specification or other information.

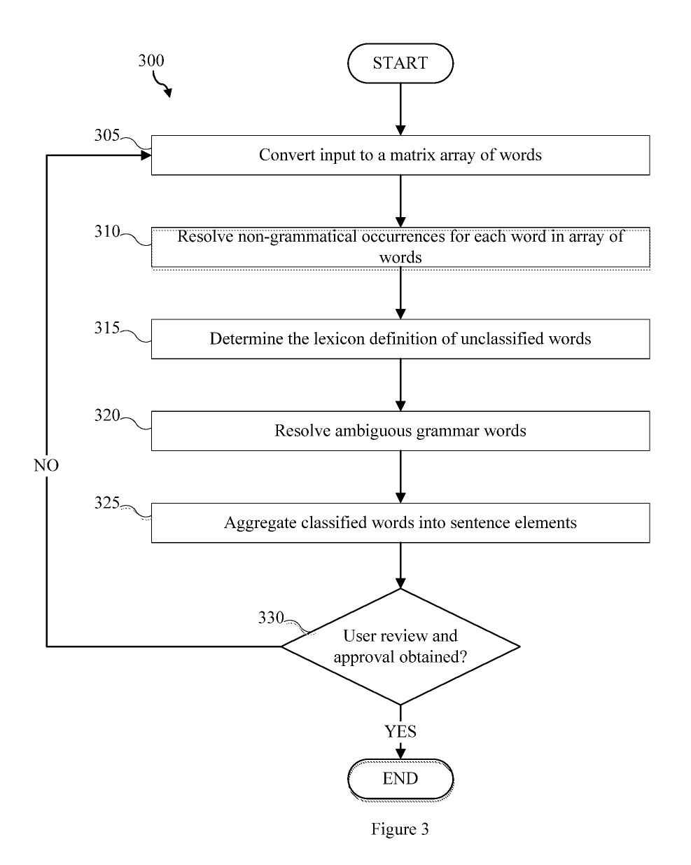

FIG. 3 illustrates a method to analyze a textual data input according to one preferred embodiment of this invention. The analysis process may occur for one segment of input at a time. In some embodiments, the input may be an excerpt of text. The excerpt may be a complete linguistic sentence, in some embodiments. In other embodiments, the input may be a set of Words or expressions. This input may then be reduced to a list of Words.

In step 305 of some preferred embodiments, the input may be converted into an array of Words, or a Word set. In some embodiments, the Word set may be plugged into a grid matrix, where subsequent analysis may be carried out and recorded. The following sentence may be organized into the Word grid matrix as follows:

“The SPECSOFTWARE shall terminate if the SPECSOFTWARE classification is not set or unreadable.” See Table 1 below.

TABLE 1

| | | |
|---|---|---|
| Item | Part of Speech(PoS) | Sentence Part (SeP) |

the
SPECSOFTWARE
shall
terminate
if
the
SPECSOFTWARE
classification
is
not
set
or
unreadable
.

In step 310, each Word of the Word set may then be examined to resolve non-grammatical occurrences that may include Idiomatic Expressions. An Idiomatic Expression is a non-grammatical expression common in spoken language that carries semantic meaning and leaks into written text. For example, the phrase ‘how much’ is lexical (i.e., both Words appear in the Lexicon), but it is non-grammatical because there is no rule that provides for an interrogative marker to be followed by an adjective.

A Lexicon is a list of Words. Each Word is associated with a PoS role. Some Words may assume ambiguous PoS's (noun-verb ambiguity), where Rules of Grammar provide case-wise guidance on resolution to one or the other PoS. A Word not present in the Lexicon Words may be left unresolved. For example, a hyphenation of two Words each of which are present in the Lexicon is left as unresolved to be resolved through rule-based resolution. These hyphenated Words are usually adjectives, but verb hyphenations are also observed where rule-based resolution applies. Rule-based resolution of a Word not found in the Lexicon refers to resolution based on the PoS identities of the Words adjacent to the unresolved Word. That is, rules may exclude the presence of a PoS adjacent (either following or preceding) some other PoS. For example, one rule states that a Verb may not follow a Preposition while another states that a Verb is likely to follow a Clause marker. Another non-lexical example is a capitalized form of a Word (Proper Noun) where the lower-case version exists in the Lexicon but where proper form of the Word carries special meaning within certain context. This is an example of a document-specific Lexicon that is handled through rule-based resolution. Another example may be an invented Word (common in software variable naming). These Words may be special-meaning Words central to a requirement or specification's definition. These Words may form part of a document-specific Lexicon that is resolved through rule-based resolution.

Rules of Grammar are a set of relationships between PoS's. In some embodiments, Rules of Grammar may provide guidance to resolve PoS ambiguity (i.e., ambiguous noun-verb preceded by an article is a noun), or may provide guidance for the aggregation of Words into phrases (e.g. rule states that a clause aggregation must include an active verb and an object noun), in other embodiments. In yet some other embodiments, Rules of Grammar may provide guidance to SeP definition (e.g., a rule states that a sentence hinges on the first active verb encountered, the subject is the first unclaimed noun that immediately precedes it, and the object is the first unclaimed noun that follows the verb). The SeP definition may imply rule-application order criticality since noun claiming occurs during phrase and clause aggregation. The SeP definition may also be considered to impose implicit additional rules related to order of application of the Grammar Rule.

Spoken language includes Idiomatic Expressions that while non-grammatical carry relevant semantic intent. For example, the expression “how much” is non-grammatical since no rule allows an interrogative to precede an adjective. However, common language usage provides a grammatical equivalent phrase “quantity of” that may be substituted without loss of meaning and that will not result in non-grammatical exceptions. Idiomatic expressions may be viewed as substitution rules. However, they do not act like grammar rules (i.e., relating Words to one another) and they do not behave like the Lexicon (i.e., assigning PoS to a Word). Rather they substitute one phrase for another, and then allow the Lexicon and grammar rules operate normally.

The term “Non-Grammatical Constructs” refers to combinations of PoS's that are not compatible. An example of this may be clause marker that is not followed by an active verb (faulty clause construct). Note that grammar rules describe open and close clause delimiters, wherein the active verb must be encountered between the delimiters. When the closure delimiter is encountered before the active verb, then faulty clause grammar exists. This may be an unclaimed active verb that is not preceded by unclaimed noun (faulty sentence construct). Note that this assumes clause and phrase aggregation has previously occurred (i.e., nouns and verbs have been claimed as parts of aggregations). Specifically, Grammatical Rules only apply when order-of-application is strictly observed. This may be described as process-sequence rule. Specifically, the same PoS sequence rule may result in different resolutions dependent on the process state where the rule was applied. The process-sequence rule is fixed and exists in the executive as a token-sequence list that refers to internal functions that themselves apply the rules. When all rules have been applied, if Words still stand alone (i.e., are unclaimed as parts of aggregations or as SeP's) then the stand-alone Words are rule exceptions, and they are flagged as non-grammatical occurrences. Non-grammatical occurrences are not allowed in the output document. In these cases, the user may be required to manually edit the sentence and resubmit it to analysis.

Consider the following examples. The term “how many” is idiomatic and translates to the normal phrase “the quantity of”. The idiomatic phrase “at a minimum” is a prepositional phrase (specifically a preposition followed by a noun) that translates to normal grammar as the adverb “minimally” that refers back to the preceding verb. In some embodiments, Words that may have been identified as an Idiomatic Expression, may be resolved to normal grammatical expressions. In these embodiments, Idiomatic Expression (semantically relevant but non-grammatical expressions) may be consolidated and classified prior to lexical look-up.

For example, in a sentence the Word ‘per’ may be substituted with the phrase ‘in accordance with.’ In some embodiments, examples of similar operations for substituting normal phrases for idiomatic or rhetorical constructs may include:
“if and when” converts to “if”
“how many” converts to “the quantity of”
“what sort” converts to “the identity”
“each time that” converts to “when”

The presence of rhetorical inclusions does not change semantic intent but may be viewed as grammatical clutter. For example, in the following sentence, the phrase substitution will occur that results in normalization of the rhetorical inclusion “per” by elimination without modification of semantic intent. Therefore:
“SPECSOFTWARE shall plan the state and the associated version of RIP on a per interface basis for DEPENDENCY.”

May be transformed to:
“SPECSOFTWARE shall plan the state and the associated version of RIP on interface basis for DEPENDENCY.”

In other embodiments, the inclusion of prepends such as ‘dis’, ‘un’, or ‘counter’ may occur along with any Lexicon entry. A module may be utilized to recognize, prepend, and mark such prepends for subsequent integration. The designation of prepends allows the normal Lexicon to address any Word that is formed of a standard Word along with a prepend. In other embodiments, ordinary punctuation may be marked to allow subsequent applications to sentence analysis.

In some embodiments, roman numerals may occur, and may be detected and marked for subsequent integration to input analysis. The presence of numerals usually indicates a symbolic reference to an enumerated list item. In these embodiments, parsing of the input may require awareness of these references for later resolution of the enumerated items into the Grammatical Context.

Alphabetic enumerations to a text item list such as ‘a)’, ‘a.’ or ‘F)’ may also be detected and marked for subsequent integration to input analysis. The presence of special notation usually indicates a symbolic reference to an enumerated list item. In these embodiments, parsing of the input may require awareness of these references for later resolution of the enumerated items into the Grammatical Context.

Pure numbers and combinations of numbers that includes punctuation may be marked as numerical groups for subsequent processing. The presence of numbers usually indicates a symbolic reference to an enumerated list item. In these embodiments, parsing of the input may require awareness of these references for later resolution of the enumerated items into the Grammatical Context.

Number groups that match data groups may be marked as such for subsequent integration to analysis. In these embodiments, parsing of the input may require rule-based awareness of these references for later resolution. Simple hyphens may be marked for subsequent integration into analysis where the hyphen normally joins two terms as a single entity. Simple slashes may also be marked for subsequent integration into analysis, where the slash usually indicates substitutability of two terms such as ‘he/she’, which the analysis considers an implicit conjunction.

In step 315, Words that may not have been resolved in step 310 above (the unclassified Word items) may then be compared to PoS context of Lexicon step 310 resolutions and classified in accordance with Lexicon rules-based standard grammatical usage, in some preferred embodiments.

Typically, the input may include unique Words that do not appear in Standard English and thus are not listed in the Lexicon. Likewise, the input may typically include proper terms formed from a sequence of Standard English Words that have special meaning as a consolidated term. The method may include adaptive rules to detect and classify unique (non-Standard English Words) and proper terms (sequences of Standard English Words) that are specific to the input and the context.

The Lexicon may be viewed as a part of the rule set wherein the presence of a specific Word results in classification to a specific PoS. In some embodiments, the specific Word may be identified within the Lexicon as Verb-Noun ambiguous. In some of these embodiments, as much as one half of the entire set of Verbs included within the Lexicon may assume the Noun or Verb PoS roles. As such the Lexicon may not be used exclusively to determine PoS. Rather, in such embodiments, a set of rules may be utilized to resolve the PoS.

This set of rules may be used to identify and resolve non-grammatical inclusions and assigning consolidated items to standard grammatical usages. In some embodiments, the set of rules may be stored within a rule set repository. The rule repository may be one source of the set of rules, in some embodiments. In other embodiments, the system may utilize one or more different sources that may be storing different sets of rules. In these embodiments, the commutative collection of the sets of rules, from the different available sources, may make up the complete set of rules. In some embodiments, any Word of the input Word list may be added to the Lexicon if any is deemed unclassifiable based on the Lexicon.

The following is an example of the process of classifying each of the input Word set according to one preferred embodiment of the invention. If the Lexicon includes a given Word, the PoS classification of this Word may be loaded into the grid along with the Word item, as illustrated in Table 2 below.

The Lexicon may be searched for the presence of each Word item in the left column. If found in the Lexicon, the Word item may be marked with the corresponding Lexicon PoS definition. In cases where additional lexical attributes such as noun or verb number are present, these attributes may also classified. The order of operations may be critical to enable precedence-oriented evaluation. Specifically, if a verb is labeled as ambiguous, this may indicate that the verb may be used either as a verb or as a noun. Ambiguous verbs may be present in both the noun and verb Lexicons. However, to avoid redundancy, only the verb Lexicon may carry the ambiguity flag, in some embodiment. When ambiguous verbs are marked, subsequent contextual evaluation may be required to resolve the use case.

In some embodiments, the ambiguous verbs may be resolved by the presence of contextual determinants to be verbs of a those particular classes. For example, a commonly encountered ambiguous Word that may be used as noun or verb is the Word “coach”, where the reference is to sporting activities. An example of sentence construction is “The coach coaches other coaches.” In this case, each occurrence of the term “coach”, whether in singular or plural form, is ambiguous in accordance with the Lexicon since each may be either a noun or verb. Resolution of the Noun-Verb ambiguity may depend on sentence context evaluation. The simplest contextual determinant may be the presence of an article preceding the ambiguous term. A second potential determinant may be the presence of an adjective just preceding the ambiguous term. Application of these two rules may resolve the first and third ambiguities nouns. The remaining ambiguity may be resolved by observing that nouns both precede and follow the remaining ambiguity. Additionally, the number of the preceding a noun (i.e., singular or plural) matches the number of its verb instantiation (i.e., singular or plural). In similar fashion, utilizing a number of like rules within the system, contextual evaluation of ambiguous Words is accomplished. The following grid update, as illustrated by Table 2 below, is a typical result of a Lexicon look-up, according to some preferred embodiments.

TABLE 2

| | | |
|---|---|---|
| Item | Part of Speech (PoS) | Sentence Part(SeP) |

| | |
|---|---|
| the | Article |
| SPECSOFTWARE | Noun(singular) |
| shall | Verb(ordinal) |
| terminate | Verb(plural) |
| if | Conditional |
| the | Article |
| SPECSOFTWARE | Noun(singular) |
| classification | Noun(singular) |
| is | Verb(singular) |
| not | Adverb |
| set | Verb(ambiguous) |
| or | Conjunction |
| unreadable | Adjective |
| . | Punctuation |

When Word-level classification based on the Lexicon is complete, aggregation logic may also be applied in accordance with PoS-to-PoS rules set to aggregate Words into phrases and clauses, in some preferred embodiments. These rules set may comprise of specific PoS-to-PoS contexts. The application of the aggregation logic, in light of the specific PoS-to-PoS contexts, may lead the aggregate Words either to consolidation with other terms, or the inclusion of missing terms that may be dropped in informal Standard English.

At the conclusion of the Word aggregation, the structure of the resulting Word set may then be assessed for Grammatical Normalcy, in some preferred embodiments. Accordingly, a set of normalization rules may be applied internally to any one of the sub phrases within the Word set. In some embodiments, the normalization rules may also be applied externally to the relationships between one or more of the sub phrases of the Word set. If a violation of the normalization rules is detected during the course of this application, a likely resolution may be applied, in accordance with the normalization rules. Specifically, there are typical non-normal Grammatical Constructs that may be observed. If any one of these non-normal Grammatical Constructs is detected, a most-likely remedy will be applied for the purposes of automatically correcting a common error. In some embodiments, these remedy decisions may be logged to provide traceability back to the original Word set construct, for the user's review and concurrence. In other embodiments, these remedy decisions may also be appended unto the normalization rules for future utilization in processing other Word sets.

For example, Word grouping normal rules may be applied to a clause such that the clause is required to include an active verb. When the clause opener encountered where the collected Word grouping does not contain the required active verb, the clause may be declared non-normal, and remediation may be required.

Inherent in standard usage, there may be numerous ambiguities of Word application. In some preferred embodiments, the Lexicon may include explicit designation of ambiguous state for specific Word entries. Words that may be defined as ambiguous grammar items may then be resolved through sentence Word context, in step 320 of some preferred embodiments of the invention. A rule set that may be used to examine ambiguous Words in the context of unambiguous Words, in some embodiments. In these embodiments, the ambiguity rule set may be used to determine and classify the applicable ambiguity case.

Table 3 below, illustrates an example of resolving an ambiguous verb that is present in another element of the Lexicon. Verb may be ambiguous by being either a noun or an adjective. The majority of Grammatical Rules may apply to resolve verb ambiguity. These rules are contextual template, where if the template of the surrounding Words matches then the ambiguity is resolved in accordance with the rule.

TABLE 3

| | | |
|---|---|---|
| Item | Part of Speech (PoS) | Sentence Part(SeP) |

| | |
|---|---|
| the | Art |
| SPECSOFTWARE | Noun(singular) |
| shall terminate | Verb(ordinal) |
| if | Conditional |
| the | Art |
| SPECSOFTWARE_{—} | Noun(singular) |
| classification | |
| is not | Verb(singular) |
| set | Adjective |
| or | Conjunction |
| unreadable | Adjective |
| . | Punctuation |

A preposition has an object and a reference. The object of the preposition may be the noun that immediately follows. The reference of the preposition may be a Word that precedes the proposition in the Word set, and the prepositional phrase may modify. Some verbs may have strong affinities to specific prepositions, where the verb may be the most likely reference. For example, the verb ‘derive’ is strongly associated with the preposition ‘from’. The solution includes a set of verbs with associated prepositions and the observed affinities of the associated preposition. Where the preposition exists subsequent to a verb with which it has a significant affinity, the verb may be declared to be the reference of the preposition, and in which case the reference verb may be modified by the prepositional phrase. If no verb affinity exists then rules of proximal noun reference may be applied.

Delimited lists of nouns are commonly included as a consolidated semantic unit. These delimited nouns may be processed into a sentence structure as a unit. In some embodiments, the current invention may provide for a set of rules for the purpose of identifying delimited lists, and concatenating its components into a consolidated grammatical Word list. Tables 4 and 5 below illustrate such input Word list and the resulting collection into a single Word list unit.

TABLE 4

| | | |
|---|---|---|
| Item | Part of Speech(PoS) | Sentence Part(SeP) |

| | |
|---|---|
| the SPECSOFTWARE | Noun(singular) |
| shall support | Verb(ordinal) |
| summarization | Noun(singular) |
| of | Preposition |
| fault_status_data | Noun(plural) |
| by | Preposition |
| type | Noun(singular) |
| , | Punctuation |
| severity | Noun(singular) |
| , | Punctuation |
| state | Noun(singular) |
| , | Punctuation |
| timestamp | Noun(singular) |
| , | Punctuation |
| and | Conjunction |
| device_ID | Noun(singular) |
| . | Punctuation |

TABLE 5

| Item | Part of Speech(PoS) | Sentence Part(SeP) |
|---|---|---|
| the SPECSOFTWARE | Noun(singular) | |
| shall support | Verb(ordinal) | |
| summarization | Noun(singular) | |
| of | Preposition | |
| fault_status_data | Noun(plural) | |
| by | Preposition | |
| type, severity, state, | Noun(singular) | ListDelim |
| timestamp, and device_ID | | |
| . | Punctuation | |

Clauses are commonly unmarked in spoken language. This practice extends into unstructured written text. To establish semantic linkages, these unmarked clauses may be explicitly defined. Tables 6 and 7 below illustrates the input to this operation, and the output after clause marking.

TABLE 6

| | | |
|---|---|---|
| Item | Part of Speech(PoS) | Sentence Part(SeP) |

| | |
|---|---|
| the SPECSOFTWARE | Noun(singular) |
| shall timestamp | Verb(ordinal) |
| fault_information | Noun(singular) |
| received | Verb (past participle) |
| from | Preposition |
| a SPECSOFTWARE | Noun(singular) |
| with | Preposition |
| the time | Noun(singular) |
| the data | Noun(plural) |
| was received | Verb(plural) |
| . | Punctuation |

TABLE 7

| | | |
|---|---|---|
| Item | Part of Speech(PoS) | Sentence Part(SeP) |

| | |
|---|---|
| the SPECSOFTWARE | Noun(singular) |
| shall timestamp | Verb(ordinal) |
| fault_information | Noun(singular) |
| where | Clause |
| fault_information | Noun(singular) |
| is received | Verb(singular) |
| from | Preposition |
| a SPECSOFTWARE | Noun(singular) |
| with | Preposition |
| the time | Noun(singular) |
| the data | Noun(plural) |
| was received | Verb(plural) |
| . | Punctuation |

Past participle forms of verbs may be utilized as adjective modifiers. If past participles are encountered under specific rule contexts, they may be declared to be adjectives. Declaration of a past participle as adjective assures proper integration of phrases for subsequent aggregation. Table 8 below illustrates this operation.

TABLE 8

| | | |
|---|---|---|
| Item | Part of Speech (PoS) | Sentence Part(SeP) |

| | |
|---|---|
| upon | Conditional |
| Operator | Noun(singular) |
| request | Noun(singular) |
| , | Punctuation |
| SPECSOFTWARE | Noun(singular) |
| shall query, shall display, | Verb(ordinal) |
| and shall update | |
| the | Art |
| Operator-configured | Adjective |
| network | Noun(singular) |
| performance_parameter | Noun(singular) |
| trends | Noun(plural) |
| . | Punctuation |

The use of verb active participles in semantic abbreviation is common. The presence of semantic abbreviation may be detected through rule context cases, and may be expand the abbreviation to normal form. For example, the following sentence expansion may occur as illustrated by Table 9 below:

“The SPECSOFTWARE shall display the set of DEPENDENCY configuration files residing on the SPECSOFTWARE.”

TABLE 9

| | | |
|---|---|---|
| Item | Part of Speech(PoS) | Sentence Part(SeP) |

| | |
|---|---|
| the | Art |
| SPECSOFTWARE | Noun(singular) |
| shall display | Verb(ordinal) |
| the | Art |
| set | Noun(singular) |
| of | Preposition |
| DEPENDENCY_{—} | Noun(singular) |
| configuration | |
| files | Noun(plural) |
| that | Clause |
| reside | Verb(plural) |
| on | Preposition |
| the | Art |
| SPECSOFTWARE | Noun(singular) |
| . | Punctuation |

Active participles of verbs that do not fit the abbreviated Semantics rules discussed above may be evaluated against a rule set to determine whether they match adjective modifier role. If an active participle is determined to be an adjective then it may be marked as such to allow integration into aggregate phrases and clauses.

Indirect requirement statements may be encountered. These are cases of hidden Semantics where unnecessary indirectness is included. Such cases may obscure the need to include a user interface. These cases may be detected through application of contextual rules and converted to normal form where the requirement for human interface may be made explicit, as illustrated by Example 1 and Example 2 below.

### Example 1

“The Software shall use stored monitoring information to generate logical representations of the monitored networks.”

The verb “shall use” is a passive reference to an underlying active requirements. In this case the active requirement is “to generate”. Therefore, the above example may be transformed to:

“The Software shall generate logical representations of the monitored networks using stored monitoring information.” In the modified sentence, indirect reference has been removed and the active verb substituted. In some embodiments, the system may include a set of rules for restructuring various commonly encountered indirect requirements.

### Example 2

“The Software shall offer Operator interface to configure requested fault status data summarization mode.”

The phrase “shall offer” is a soft requirement indicating optional implementations vice an explicit software feature. This is bad requirement statement.

The phrase “to configure” is the real requirement to be implemented by software with the qualification that it is optional based on user election.

This example provides indirect requirement through a reference to second requirement. The active requirement is “to configure” where the implementation requirement is to provide a user interface feature. Therefore, this example may be transformed to:

“When user requests, the Software shall configure requested fault status data summarization mode.” The grammar here is normalized by stating the interface requirement as a conditional phrase that precedes the active requirement as direct expression. This example introduces a convention of the patent that conditional statements that refer to a software user always identifies an interface requirement. Such normal conventions may be utilized for automated requirement extraction in subsequently analyzed expressions.

The original requirement implies both the requirement to configure something and the need to provide User Interface (UI) to access to the function. The second makes both explicit and allows for automated delineation of function design tasks (UI versus internal configuration logic).

The method according to some embodiments of this invention may aggregate Words associated with clauses as a semantic unit for subsequent sentence level analysis. A rule set may be utilized to define the content completeness for the clause and continues aggregation until the rule set is satisfied or violated (grammatical error case may be detected). See Table 10 below.

TABLE 10

| | | |
|---|---|---|
| Item | Part of Speech(PoS) | Sentence Part(SeP) |

| | |
|---|---|
| the SPECSOFTWARE | Noun(singular) |
| shall timestamp | Verb(ordinal) |
| fault_information | Noun(singular) |
| where fault_information is | Clause |
| received | |
| from a SPECSOFTWARE | Prep Phrase |
| with the time | Prep Phrase |
| the data | Noun(plural) |
| was received | Verb(plural) |
| . | Punctuation |

Based on clause closure above, the reference of the clause may be determined and integrated into the clause. Clauses are complete sentences that are included within a sentence (i.e. an internal sentence). These internal sentences often do not explicitly include the subject of the sentence, but may include it without creating a grammatical error case. Such clauses may be normalized by using rules to determine the implied subject and may integrate the implied subject into the sentence as illustrated below:

“SPECSOFTWARE shall allow the Operator to monitor multi-channel Dependent Items playing the role of intra-domain gateways.”

Intermediate conversion form indirect requirement:

“When the Operator requests, SPECSOFTWARE shall monitor multi-channel Dependent Items playing the role of intra-domain gateways.”

Final resolution where unmarked clause with best-guess clause subject are installed:

“When the Operator requests, SPECSOFTWARE shall monitor multi-channel Dependent Items where the multi-channel Dependent Items are playing the role of intra-domain gateways.”

The following is another example of applying the above final resolution technique. In this example, a past participle preceding a preposition is a non-normal Grammatical Construct. This case is an unmarked-clause that often occurs in spoken grammar but results in imperfect semantic parsing by automated analysis. In some embodiments, the clause marker (where) and the missing verb (is) are installed, and the best-guess at the reference of the clause may be installed as the clause subject. The corresponding Word matrix transition is illustrated in Tables 11 and 12 below.

TABLE 11

| | | |
|---|---|---|
| Item | Part of Speech (PoS) | Sentence Part(SeP) |

| | |
|---|---|
| the SPECSOFTWARE | Noun(singular) |
| shall timestamp | Verb(ordinal) |
| fault_information | Noun(singular) |
| received | Verb (past participle) |
| from | Preposition |
| another SPECSOFTWARE | Noun(singular) |
| with | Preposition |
| the time | Noun(singular) |
| the data | Noun(plural) |
| was received | Verb(plural) |
| . | Punctuation |

TABLE 12

| | | |
|---|---|---|
| Item | Part of Speech (PoS) | Sentence Part(SeP) |

| | |
|---|---|
| the SPECSOFTWARE | Noun(singular) |
| shall timestamp | Verb(ordinal) |
| fault_information | Noun(singular) |
| where | Clause |
| fault_information | Noun(singular) |
| is received | Verb(singular) |
| from | Preposition |
| another_{—} | Noun(singular) |
| SPECSOFTWARE | |
| with | Preposition |
| the time | Noun(singular) |
| the data | Noun(plural) |
| was received | Verb(plural) |
| . | Punctuation |

Conditional phrases follow the rules of clause aggregation, but may result in a condition that validates the imposition of the requirement. Following Word-level classification, remaining content is scanned to classify unclaimed Words in accordance with and unclaimed Word rule set to assign them to particular PoS along with associated PoS attributes.

In step 325 of some preferred embodiments, the classified Word list may be aggregated into sentence elements. In some preferred embodiments, the aggregation may be applied through application of a sentence structure rule set. Sentence parts (SeP) may be defined within the sentence structure rule set as semantic entities (for example, clauses, phrases, etc.) that may be linked through semantic activities (for example, verbs, etc.). Unit-level and compound structures within the input may be identified through the sentence structure rules set for the purpose of identifying unit-level semantic content, in some embodiments. A unit-level requirement is a sentence that contains one subject (the object that must fulfill a requirement), one active verb (the activity that is required) and one object (context where the requirement must be fulfilled). A compound requirement is a statement where one of the three elements has been conjoined to another like element (for example, where two or more active verbs are conjoined) as in the following example.

“The SPECSOFTWARE shall encrypt and sign data reduction files and folders.”

In this example (illustrated in tables 13 and 14 below), the active verb is compounded and the object context is compound. The human reader may analyze the compounding permutations to ensure that the true scope of the requirement has been understood. In some preferred embodiments, reduction to unit-level requirements may be as follows.

“The SPECSOFTWARE shall encrypt data reduction files.”

“The SPECSOFTWARE shall sign data reduction files.”

“The SPECSOFTWARE shall encrypt data reduction folders.”

“The SPECSOFTWARE shall sign data reduction files.”

In some embodiments, the system may impose inheritance of modifiers during unit-level reduction. In this example, the adjective modifier “data reduction” is distributed to both “files” and “folders” by default. It is commonly the case where writers employ compounding of requirements that this inheritance in inadvertent and unintended. In these embodiments, the system may impose review and approval by the writer of the compound inheritance to resolve such inadvertent inheritance. Note that final approval may require a discrete test for each of the compounded requirements, and the system may make explicit this compounded requirement implementation and associated testing requirement. Where a compound requirement has been reduced to a number of unit-level requirements, any conditional precedents, clauses or phrases present in the compound statement may be distributed to (that is, inherited by) the unit-level requirements.

TABLE 13

| Item | Part of Speech(PoS) | Sentence Part (SeP) |
|---|---|---|
| the SPECSOFTWARE | Noun(singular) | Subject |
| shall encrypt and shall sign | Verb(ordinal) | Verb |
| data reduction files and | Noun(plural) | Direct Object |
| folders | | |
| . | Punctuation | |

TABLE 14

| Item | Part of Speech(PoS) | Sentence Part (SeP) |
|---|---|---|
| the SPECSOFTWARE | Noun(sing) | Subject |
| shall encrypt | Verb(ordinal) | Verb |
| data reduction files | Noun(pl) | Direct Object |
| And | Conjunction | |
| the SPECSOFTWARE | Noun(sing) | Subject |
| shall sign | Verb(ordinal) | Verb |
| data reduction files | Noun(pl) | Direct Object |
| And | Conjunction | |
| the SPECSOFTWARE | Noun(sing) | Subject |
| shall encrypt | Verb(ordinal) | Verb |
| folders | Noun(pl) | Direct Object |
| And | Conjunction | |
| the SPECSOFTWARE | Noun(sing) | Subject |
| shall sign | Verb(ordinal) | Verb |
| folders | Noun(pl) | Direct Object |
| . | Punctuation | |

Compound structured input (complex semantic units) may also be restated as separate Word sets or sentences (unitary semantic units), to provide explicit requirement unit identification. In these embodiments, at the conclusion of applying these unit-level separation operations (for example, when the sentence has been restructured), or in some cases, when the completeness of the input does not conform to the sentence structure rules, the user may be prompted. Likewise when the permutations of the compounding have been resolved as in Table 14, the author may be required to validate that all permutations of compounding are within the scope of the intended requirement. Specifically, the expense of doubly encrypting both files and folders within which the files are stored, may drive cost and complexity of the project. For example, consider the input: “SPECSOFTWARE shall analyze network performance data and compute the network performance parameter trends at the rate set by the Operator.”

The input may be broken to the following requirement units:

“SPECSOFTWARE shall analyze network performance data.”

and

“SPECSOFTWARE shall compute the network performance parameter trends at the rate where the rate is set by the Operator.”

The following are some examples of different operations that may be carried out in step 325, in some preferred embodiments of this invention.

Sentence structure analyzes the Word declarations and aggregation to identify the critical inclusions for a complete sentence, as illustrated in Table 14 below.

TABLE 14

| Item | Part of Speech(PoS) | Sentence Part(SeP) |
|---|---|---|
| when the Operator requests | Conditional | |
| , | Punctuation | |
| SPECSOFTWARE | Noun(singular) | Subj |
| shall query and shall | Verb(ordinal) | Verb |
| display | | |
| the state | Noun(singular) | DirObj |
| of Dependent Items | Prep Phrase | Adjective<state> |
| after activation where the | Conditional | Event Case |
| activation follows restart | | |
| . | Punctuation | |

In cases, unexpected sentence content may be a conjoined sentence. In such cases, the conjoined sentence may inherit the subject from the previously defined sentence, where the verb case may inherit the verb ordinal from the original sentence. See Table 15 and Table 16 below.

Initial state of analysis:

TABLE 15

| Item | Part of Speech(PoS) | Sentence Part(SeP) |
|---|---|---|
| the SPECSOFTWARE | Noun(singular) | Subj |
| shall verify | Verb(ordinal) | Verb |
| that the report is signed | Clause | Rel |
| , | Punctuation | |
| And | Conjunction | |
| notify | Verb(plural) | Verb |
| the | Noun(singular) | DirObj |
| SPECSOFTWARE_user | | |
| if the signature is not valid | Conditional | |
| . | Punctuation | |

Final state of analysis:

TABLE 16

| Item | Part of Speech(PoS) | Sentence Part(SeP) |
|---|---|---|
| the SPECSOFTWARE | Noun(singular) | Subj |
| shall verify | Verb(ordinal) | Verb |
| that the report is signed | Clause | Rel |
| , | Punctuation | |
| And | Conjunction | |
| the SPECSOFTWARE | Noun(singular) | Subj |
| shall notify | Verb(ordinal) | Verb |
| the | Noun(singular) | DirObj |
| SPECSOFTWARE _user | | |
| if the signature is not valid | Conditional | |
| . | Punctuation | |

At the conclusion of the above analysis is completed, faulty sentences may be flagged for resolution, as illustrated by Table 17 below.

TABLE 17

| Item | Part of Speech(PoS) | Sentence Part(SeP) |
|---|---|---|
| SPECSOFTWARE | Noun(singular) | Subj |
| shall utilize | Verb(ordinal) | Verb |
| the signature_algorithms | Noun(plural) | DirObj |
| with 1024_bit_public_key | Prep Phrase | Adverb<shall |
| | | utilize> |
| And | Conjunction | Case3 |
| the hash_algorithms | Noun(plural) | Unexpected Noun |
| when digitally | Conditional | |
| signing_data | | |
| And | Conjunction | Case4 |
| when verifying_data | Conditional | |
| . | Punctuation | |

In the event a faulty or nonconforming Word set persists at the conclusion of the above analysis and processing, an operation to determine the normal structure likely intended, based on internal rules, may be carried out, in some preferred embodiments. The Word set in questions may be edited to the most likely normal state, and may be flagged for concurrence by a user. See Table 18 below. In the case illustrated, the preposition associated with the preceding noun is inherited by the unexpected noun and grammar normalization restored.

TABLE 18

| Item | Part of Speech(PoS) | Sentence Part(SeP) |
|---|---|---|
| SPECSOFTWARE | Noun(singular) | Subj |
| shall utilize | Verb(ordinal) | Verb |
| the signature_algorithms | Noun(plural) | DirObj |
| with 1024_bit_public_key | Prep Phrase | Adverb<shall |
| | | utilize> |
| And | Conjunction | |
| with the hash_algorithms | Prep Phrase | Adverb refers to |
| | | <shall utilize> |
| when digitally | Conditional | |
| signing_data | | |
| And | Conjunction | |
| when verifying_data | Conditional | |
| . | Punctuation | |

Conditional phrases that may have been identified and aggregated may be moved to the most likely point of conditional application. For a simple Word set structure with a singular requirement statement and a single conditional clause, the conditional clause may be moved to the beginning of the sentence. This results in the normal form of if-condition-then-required action. In the case of compound and conjoined sentences, the determination of conditional positioning may be based on rules provided, in some embodiments.

TABLE 19

| Item | Part of Speech(PoS) | Sentence Part(SeP) |
|---|---|---|
| when digitally | | Conditional |
| signing_data | | |
| and | Conjunction | |
| when verifying_data | | Conditional |
| SPECSOFTWARE | Noun(singular) | Subj |
| shall utilize | Verb(ordinal) | Verb |
| the signature_algorithms | Noun(plural) | DirObj |
| with 1024_bit_public_key | Prep Phrase | Adverb<shall |
| | | utilize> |
| and | Conjunction | |
| with the hash_algorithms | Prep Phrase | Adverb<shall |
| | | utilize> |
| . | Punctuation | |

The result of the parsing process may then be presented to the user for concurrence or manual editing. A typical case where a single statement includes multiple requirements with indirect inclusions is as follows:

“SPECSOFTWARE shall allow the Security Officer to import, list, view, print security related templates, select templates for a mission, list templates for a mission, and delete selected templates after the request to delete has been confirmed.”

The submitted text is grammatically analyzed to the following fundamental classified structure. See Table 20 below

TABLE 20

| Item | Part of Speech(PoS) |
|---|---|
| when the Security Officer requests | Conditional |
| , | Punctuation |
| SPECSOFTWARE | Noun(sing) |
| shall import | Verb(ordinal) |
| , | Punctuation |
| shall list | Verb(ordinal) |
| , | Punctuation |
| shall view | Verb(ordinal) |
| , | Punctuation |
| shall print | Verb(ordinal) |
| security related templates | Noun(pl) |
| , | Punctuation |
| shall select | Verb(pl) |
| Templates | Noun(pl) |
| for a mission | Prep Phrase |
| , | Punctuation |
| shall list | Verb(ordinal) |
| Templates | Noun(pl) |
| for a mission | Prep Phrase |
| And | Conjunction |
| shall delete | Verb(ordinal) |
| selected templates | Noun(pl) |
| after the request to delete has been | Conditional |
| confirmed | |
| . | Punctuation |

The classified structure may contain implicit references to subjects and objects that are missing from the classified text. To resolve complete semantic structures, the may estimate which subjects and objects are to be distributed to the semantically incomplete structures in order to achieve semantic completion and grammatical normalcy. These complete semantic units may then be substituted into the analytical structure as illustrated by Table 21 below.

TABLE 21

| Item | Part of Speech(PoS) |
|---|---|
| when the Security Officer requests | Conditional |
| , | Punctuation |
| SPECSOFTWARE | Noun(sing) |
| shall import | Verb(ordinal) |
| security-related templates | Noun(pl) |
| , | Punctuation |
| SPECSOFTWARE | Noun(sing) |
| shall list | Verb(ordinal) |
| security-related templates | Noun(pl) |
| , | Punctuation |
| SPECSOFTWARE | Noun(sing) |
| shall view | Verb(ordinal) |
| security-related templates | Noun(pl) |
| , | Punctuation |
| SPECSOFTWARE | Noun(sing) |
| shall print | Verb(ordinal) |
| security-related templates | Noun(pl) |
| , | Punctuation |
| SPECSOFTWARE | Noun(sing) |
| shall select | Verb(ordinal) |
| Templates | Noun(pl) |
| for a mission | Prep Phrase |
| , | Punctuation |
| SPECSOFTWARE | Noun(sing) |
| shall list | Verb(ordinal) |
| Templates | Noun(pl) |
| for a mission | Prep Phrase |
| And | Conjunction |
| , | Punctuation |
| SPECSOFTWARE | Noun(sing) |
| shall delete | Verb(ordinal) |
| selected templates | Noun(pl) |
| after the request to delete has been | Conditional |
| confirmed | |
| . | Punctuation |

When the semantic completion is accomplished, the semantically complete statements may be dissected to specific statements. In the context of contractual commitment, each statement may be a legally binding requirement. The dissected requirements may explicitly express the full contractual requirements as illustrated by Tables 22 through 28 below.

Requirement Dissection 1

TABLE 22

| Item | Part of Speech(PoS) |
|---|---|
| when the Security Officer requests | Conditional |
| , | Punctuation |
| SPECSOFTWARE | Noun(sing) |
| shall import | Verb(ordinal) |
| security-related templates | Noun(pl) |
| . | Punctuation |

Requirement Dissection 2

TABLE 23

| Item | Part of Speech(PoS) |
|---|---|
| SPECSOFTWARE | Noun(sing) |
| shall list | Verb(ordinal) |
| security-related templates | Noun(pl) |
| . | Punctuation |

Requirement Dissection 3

TABLE 24

| Item | Part of Speech(PoS) |
|---|---|
| SPECSOFTWARE | Noun(sing) |
| shall view | Verb(ordinal) |
| security-related templates | Noun(pl) |
| . | Punctuation |

Requirement Dissection 4

TABLE 25

| Item | Part of Speech(PoS) |
|---|---|
| SPECSOFTWARE | Noun(sing) |
| shall print | Verb(ordinal) |
| security-related templates | Noun(pl) |
| . | Punctuation |

Requirement Dissection 5

TABLE 26

| Item | Part of Speech(PoS) |
|---|---|
| SPECSOFTWARE | Noun(sing) |
| shall select | Verb(ordinal) |
| Templates | Noun(pl) |
| for a mission | Prep Phrase |
| . | Punctuation |

Requirement Dissection 6

TABLE 27

| Item | Part of Speech(PoS) |
|---|---|
| SPECSOFTWARE | Noun(sing) |
| shall list | Verb(ordinal) |
| Templates | Noun(pl) |
| for a mission | Prep Phrase |
| . | Punctuation |

Requirement Dissection 7

TABLE 28

| Item | Part of Speech(PoS) |
|---|---|
| SPECSOFTWARE | Noun(sing) |
| shall delete | Verb(ordinal) |
| selected templates | Noun(pl) |
| after the request to delete has been | Conditional |
| confirmed | |
| . | Punctuation |

In some embodiments, at the conclusion of the input reconstruction process, the user may be required to approve the restructured output or set of unit level sentences, as illustrated in step 330. The user may have the choice of either approving the system's reconstruction of the input Word set, or sentence in some cases, or the user may edit the reconstruction of the original input. In these embodiments, the user's edits to the reconstruction of the input may then be resubmitted to the system for re-analysis.

Applying to the above example, an originator of the requirement may be asked or required to approve the unit requirement partitioning analysis. If the originator disagrees, the originator may restate the requirement. The restated requirement may then go through the same analysis until the originator approves.

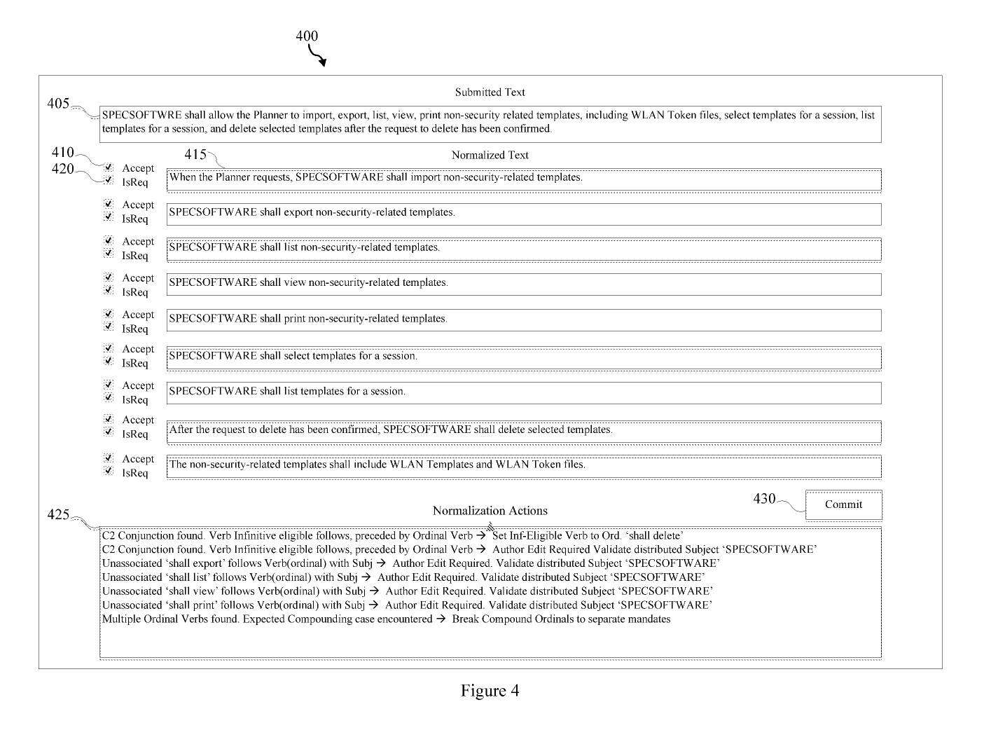

After the automated resolution of the compound requirements, the normalized requirements may be reconstructed for user review using a final review module 400, as illustrated by FIG. 4. The normalized reconstructions may be presented for final concurrence. The produced output may be compared to the original input. If the input is determined to be identical to the output, then the produced output Word set or sentence may then be finally be accepted or approved by the user. If the user is in agreement with the sentence structure, then the user intent has been expressed within normal grammar construct, and the Word set or sentence may be integrated into a finalized document, in some embodiments.

The user may examine the original form of a requirement submission in the ‘Submitted Text’ box 405 along with the extracted requirements presented in a series of following ‘Normalized Text’ boxes 415. The number of extracted requirements may depend on the complexity of the original text and the rule-based actions applied by the analysis. ‘Normalization Actions’ box 425 presents a list of the rules applied within the analysis where the resulting action is presented.

If the user does not agree that the reconstruction is equivalent to the intent of the original statement, the user may manually edit the statement to conform to the original intent. Manually edited statements may be resubmitted to the normalization analysis at step 305 of FIG. 3, for assessment of the manually edited text for conformance to normal form.

The user may accept a derived requirement by checking Accept box 410 where a lack of check in box 410 drops the requirement from the final requirement document as an invalid requirement. If the user determines that a normalized statement 415 should not be a binding requirement, removal of the statement may be accomplished by non-acceptance (e.g., leaving Accept box 410 unchecked). If the user determines that a statement 415 is outside of the scope of the binding requirements, but should be included for pedagogical purposes (i.e., intent clarification), the statement may be accepted by checking the Accept box 410, while the IsReq box 420 may be left unchecked. These statements may be included in the normalized specification, but may not be considered a binding requirement.

If the user checks the IsReq box 420, the requirement may be accepted as a binding requirement. In some preferred embodiments, if the user does not check box 420, the statement may be included in the final requirement document as a tutorial statement, for example, that supports implementation of other requirements but may not be binding.

If the user determines that the normalized text matches the intent of the original text, the Accept box 410 and the IsReq box 420 may both be checked. If the user review is complete, the user may press the Commit button 430, thereupon the next requirement may be included in the normalized specification, and the next statement may be reviewed.

If all requirements are committed, the requirement base may be reconstructed as a normalized requirement base. The normalized requirement base may be used to reconstruct a normalized specification or may be directly submitted to the requirement database management tool.

What is claimed is:

1. A computer-implemented method for normalizing grammar of textual data, comprising the steps of:
providing access to a computer memory configured to store the textual data;
providing access to a network, wherein the computer memory is connected to the network;
dividing the textual data into a plurality of words;
inserting each of the plurality of words into a matrix;
determining whether any of the plurality of words is a non-grammatical expression;
in response to determining a first word of the plurality of words is a non-grammatical expression, replacing the first word with a second word into the matrix, wherein the second word is a grammatical and semantic equivalent of the first word;
determining the Part of Speech (PoS) classification for each of the words in the matrix;
in response to determining the PoS classification for each of the words in the matrix, determining whether a third word in the matrix has an ambiguous PoS classification;
in response to determining the third word has an ambiguous PoS classification, resolving the ambiguous PoS classification of the third word;
aggregating the plurality of words into one or more phrases; and
presenting the one or more phrases to a user for approval.

2. The method of claim 1, wherein the first word is an idiomatic expression.

3. The method of claim 1, wherein the step of determining whether the first word is a non-grammatical expression comprising the steps of:
determining whether the first word exists in a lexicon; and
in response to determining the first word exists in the lexicon, determining whether a position of the first word in the matrix is not supported by any of a plurality of grammar rules.

4. The method of claim 3, wherein the lexicon is stored in the computer memory.

5. The method of claim 3, wherein the plurality of grammar rules are stored in one or more grammar rules repositories.

6. The method of claim 5, wherein at least one of the one or more grammar rules repositories is stored in the computer memory.

7. The method of claim 1, wherein the step of replacing the first word with a second word into the matrix, comprising the steps of:
looking up the second word from a lexicon, where the first word and the second word share the same meaning; and
determining whether the position of the second word in the matrix is supported by any of a plurality of grammar rules.

8. The method of claim 7, wherein the lexicon is stored in the computer memory.

9. The method of claim 7, wherein the plurality of grammar rules are stored in one or more grammar rules repositories.

10. The method of claim 9, wherein at least one of the grammar rules repositories is stored in the computer memory.

11. The method of claim 1, wherein the step of determining the Part of Speech (PoS) classification for each of the words in the matrix comprising the steps of:
determining whether each of the words in the matrix exist in a lexicon;
in response to determining a fourth word in the matrix exists in the lexicon, determining the corresponding lexicon PoS definition of the fourth word; and
storing the lexicon PoS definition of the fourth word in the matrix.

12. The method of claim 11, wherein the lexicon PoS definition of the fourth word comprising an ambiguity flag.

13. The method of claim 11, wherein the lexicon is stored in the computer memory.

14. The method of claim 1, wherein the step of resolving the ambiguous PoS classification of the third word comprising the step of evaluating the context of the third word.

15. The method of claim 14, wherein the step of evaluating the context of the third word comprising the steps of:
determining whether an article precedes the third word;
determining whether an adjective precedes the third word;
determining whether a preposition precedes the third word.

16. The method of claim 1, further comprising the steps of:
detecting any non-normal grammatical construct in the one or more phrases; and
in response to detecting a non-normal grammatical construct in the one or more phrases, replacing the non-normal grammatical construct with a normal grammatical construct, wherein the normal grammatical construct is a semantic equivalent of the non-normal grammatical construct.

17. The method of claim 16, wherein the step of replacing the non-normal grammatical construct with a normal grammatical construct, comprising the steps of:
looking up the normal grammatical construct from a lexicon, where the non-normal grammatical construct and the normal grammatical construct share the same semantic meaning; and
determining whether the position of the normal grammatical construct in the matrix is supported by any of a plurality of grammar rules.

18. The method of claim 17, wherein the lexicon is stored in the computer memory.

19. The method of claim 17, wherein the plurality of grammar rules are stored in one or more grammar rules repositories.

20. The method of claim 19, wherein at least one of the grammar rules repositories is stored in the computer memory.

21. A non-transitory computer-readable medium for normalizing grammar of textual data, comprising instructions stored thereon, that when executed on a processor, perform the steps comprising:
dividing the textual data into a plurality of words;
inserting each of the plurality of words into a matrix;
determining whether any of the plurality of words is a non-grammatical expression;
in response to determining a first word of the plurality of words is a non-grammatical expression, replacing the first word with a second word into the matrix, wherein the second word is a grammatical and semantic equivalent of the first word;
determining the Part of Speech (PoS) classification for each of the words in the matrix;
in response to determining the PoS classification for each of the words in the matrix, determining whether a third word in the matrix has an ambiguous PoS classification;
in response to determining the third word has an ambiguous PoS classification, resolving the ambiguous PoS classification of the third word;
aggregating the plurality of words into one or more phrases; and
presenting the one or more phrases to a user for approval.
